(19) United States
(12) Patent Application Publication
(10) Pub. No.: US 2022/0207249 A1
(43) Pub. Date: Jun. 30, 2022

(54) CARD READER AND TRANSACTION APPARATUS

(71) Applicant: NIDEC SANKYO CORPORATION, Nagano (JP)

(72) Inventor: Keiji MIYAZAWA, Nagano (JP)

(21) Appl. No.: 17/563,266

(22) Filed: Dec. 28, 2021

(30) Foreign Application Priority Data
Dec. 28, 2020 (JP) 2020-218243

(51) Int. Cl. G06K 7/08; G06K 7/01

(52) U.S. Cl. CPC G06K 7/087; G06K 7/01

(57) ABSTRACT

A card reader includes a front wall where an insertion slot opens, a conveyance path extending from the insertion slot toward a back side, a magnetic head configured to read information from a card conveyed along the conveyance path, a conveyance mechanism configured to convey the card inserted into the insertion slot along the conveyance path, an entry sensor configured to detect that the card has been inserted into the insertion slot, and a controller. The controller performs an insertion monitoring start instruction step to start monitoring insertion of the card by the entry sensor upon receipt of an initialization command transmitted from a higher-level device and a carry-in start instruction step to start carry-in of the card by the conveyance mechanism when the entry sensor detects the insertion of the card.

### CROSS REFERENCE TO RELATED APPLICATION

The present application claims priority under 35 U.S.C. § 119 to Japanese Application No. 2020-218243 filed on Dec. 28, 2020, the entire content of which is incorporated herein by reference.

### BACKGROUND

### Field of the Invention

At least an embodiment of the present invention relates to a card reader and a transaction apparatus for performing a transaction or the like with the use of a card inserted through a card insertion slot.

### Description of the Related Documents

A card reader has a magnetic head that reads magnetic information from a card inserted from a card insertion slot, and is mounted on a transaction apparatus such as an automatic teller machine (ATM) and a point-of-sale system (POS system). In such a card reader, a method for manually inserting and pulling out a card has been proposed (see Japanese Unexamined Patent Application Publication No. 2020-113357). In the manual type card reader described in Japanese Unexamined Patent Application Publication No. 2020-113357, a card is manually inserted or pulled out with the use of a recess hollowed out except for the portion where the magnetic head is disposed and the portion where both ends of the card pass through. In addition, when the card is inserted to the position where the rear end of the card passes through the magnetic head, the tip of the card butts up against the end of the housing and communication with the IC card takes place at that position. The magnetic data is read when the card is inserted and when the card is pulled out.

Manual card readers are used domestically and internationally in parking lot payment machines and drive-through transaction apparatuses. However, since manual card readers perform magnetic read, the card must be inserted and pulled out at as constant speed as possible, but when operated from inside the car, the card insertion and pull-out are unstable and magnetic read errors are likely to occur. For this reason, it is desirable to mount an assist type card reader that uses motorized conveyance or the like in parking lot payment machines and drive-through transaction apparatuses. In such cases, the control on the higher-level device side of the card reader must be changed to accommodate the assist type card reader.

In view of the above-described issues, an object of at least an embodiment of the present invention is to provide a card reader and a transaction apparatus which do not need to change the control in a higher-level device even when the card handling is changed from a manual type to an assisted type using motor conveyance or the like.

### SUMMARY

In order to solve the above issue, a card reader according to at least an embodiment of the present invention includes a front wall where an insertion slot opens, a conveyance path extending from the insertion slot toward a back side, a magnetic head configured to read information from a card conveyed along the conveyance path, a conveyance mechanism configured to convey the card inserted into the insertion slot along the conveyance path, an entry sensor configured to detect that the card has been inserted into the insertion slot, and a controller. The controller performs an insertion monitoring start instruction step to start monitoring insertion of the card by the entry sensor upon receipt of an initialization command transmitted from a higher-level device and a carry-in start instruction step to start carry-in of the card by the conveyance mechanism when the entry sensor detects the insertion of the card.

In addition, at least an embodiment of the present invention is a transaction apparatus including a card reader and a higher-level device to control the card reader. The card reader includes a front wall where an insertion slot opens, a conveyance path extending from the insertion slot toward a back side, a magnetic head configured to read information from a card conveyed along the conveyance path, a conveyance mechanism configured to convey the card inserted into the insertion slot along the conveyance path, an entry sensor configured to detect that the card has been inserted into the insertion slot, and a controller. The controller performs an insertion monitoring start instruction step to start monitoring insertion of the card by the entry sensor upon receipt of an initialization command transmitted from the higher-level device and a carry-in start instruction step to start carry-in of the card by the conveyance mechanism when the entry sensor detects the insertion of the card.

In the card reader and transaction apparatus according to this aspect, an insertion monitoring start instruction step to start monitoring insertion of the card by the entry sensor is performed by an initialization command that has been output from the higher-level device in a card reader without a conveyance mechanism. Thus, when changing from a card reader without a conveyance mechanism to the card reader with a conveyance mechanism according to this aspect, it is not necessary to change the configuration of the higher-level device. Accordingly, it is easy to switch from a card reader without a conveyance mechanism to a card reader with the conveyance mechanism.

In the card reader and transaction apparatus according to this aspect, an aspect can be employed in which a carry-out start instruction step to start carry-out of the card by the conveyance mechanism upon receipt of a card pull-out monitoring command transmitted from the higher-level device and an insertion monitoring resumption instruction step to resume monitoring the insertion of the card by the entry sensor when the entry sensor detects carry-out of the card are performed. According to such aspect, a carry-out start instruction step to start carry-out of the card is performed by the card pull-out monitoring command that has been output from the higher-level device in a card reader without a conveyance mechanism. Thus, when changing from a card reader without a conveyance mechanism to the card reader with a conveyance mechanism according to this aspect, it is not necessary to change the configuration of the higher-level device. Accordingly, it is easy to switch from a card reader without a conveyance mechanism to a card reader with the conveyance mechanism.

In the card reader and transaction apparatus according to this aspect, as aspect can be employed in which the card reader includes a front sensor configured to detect presence or absence of the card on an upstream side of the conveyance path, and a rear sensor configured to detect presence or absence of the card on a downstream side of the conveyance path, and after the carry-in start instruction step, the controller stops the carry-in of the card by the conveyance mechanism on a basis of a detection result by the front sensor that the card is present and a detection result by the rear sensor that the card is present, and after the carry-out start instruction step, the controller stops the carry-out of the card by the conveyance mechanism on a basis of a detection result by the front sensor that the card is absent and a detection result by the rear sensor that the card is absent.

In the card reader and transaction apparatus according to at least an embodiment of the present invention, an insertion monitoring start instruction step to start monitoring insertion of the card by the entry sensor is performed by an initialization command that has been output from the higher-level device in a card reader without a conveyance mechanism. Thus, when changing from a card reader without a conveyance mechanism to the card reader with a conveyance mechanism according to at least an embodiment of the present invention, it is not necessary to change the configuration of the higher-level device. Accordingly, it is easy to switch from a card reader without a conveyance mechanism to a card reader with the conveyance mechanism.

### BRIEF DESCRIPTION OF THE DRAWINGS

Embodiments will now be described, by way of example only, with reference to the accompanying drawings which are meant to be exemplary, not limiting, and where like elements are numbered alike in several figures, in which:

FIG. 1 is an explanatory diagram illustrating a schematic configuration or the like of a card reader to which at least an embodiment of the present invention has been applied.

FIG. 2 is a perspective view of a card reader to which at least an embodiment of the present invention has been applied.

FIG. 3 is an explanatory of the front of the card reader illustrated in FIG. 1, viewed from diagonally above.

FIG. 4 is an exploded perspective view of the card reader illustrated in FIG. 1 with a front cover removed.

FIG. 5 is an exploded perspective view of the card reader illustrated in FIG. 2 with a conveyance mechanism removed, viewed from the diagonally left side.

FIG. 6 is an exploded perspective view of the card reader illustrated in FIG. 2 with a conveyance mechanism removed, viewed from the diagonally right side.

FIG. 7 is an exploded perspective view of the conveyance mechanism illustrated in FIG. 6.

FIG. 8 is an explanatory diagram of a shield plate provided in the card reader illustrated in FIG. 2.

FIG. 9 is an explanatory diagram of coupling members for fixing the shield plate illustrated in FIG. 8.

FIG. 10 is an explanatory diagram illustrating a schematic operation of a card reader and a transaction apparatus, to which at least an embodiment of the present invention has been applied.

### DETAILED DESCRIPTION

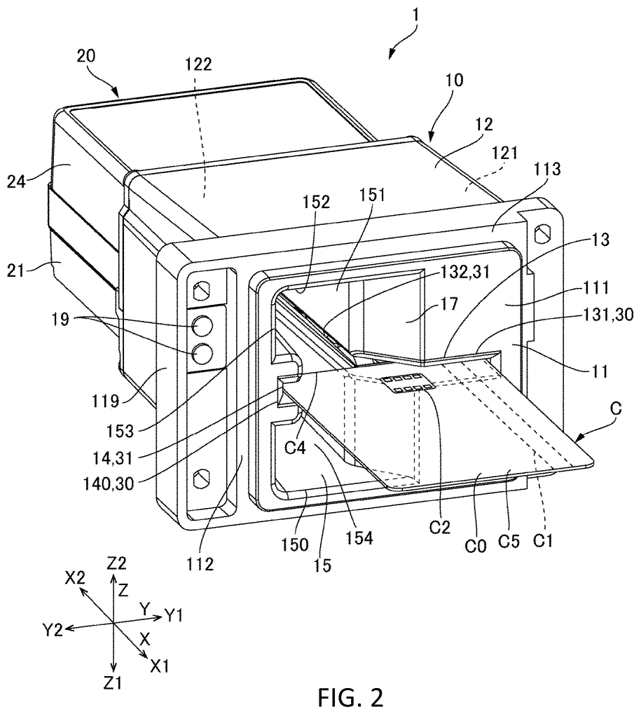

An embodiment of the present invention will now be described with reference to the accompanying drawings. In the following description, a card C moves in a front-rear direction X illustrated in FIG. 2 and the like. An up-down direction Z is a thickness direction of the card C, and a right-left direction Y is a direction orthogonal to the front-rear direction X and the up-down direction Z. In the following description, the front side is marked with X1, the rear side is marked with X2, the right side is marked with Y1, the left side is marked with Y2, the lower side is marked with Z1, and the upper side is marked with Z2. The front side X1 corresponds to the front side of a conveyance path 31 of the card C, and the rear side X2 corresponds to the back side of the conveyance path 31 of the card C. A front end C4 of the card C corresponds to the side that precedes the card C when it is inserted, and a rear end C5 of the card C corresponds to the side opposite to the side that precedes the card C when it is inserted.

### Overall Configuration

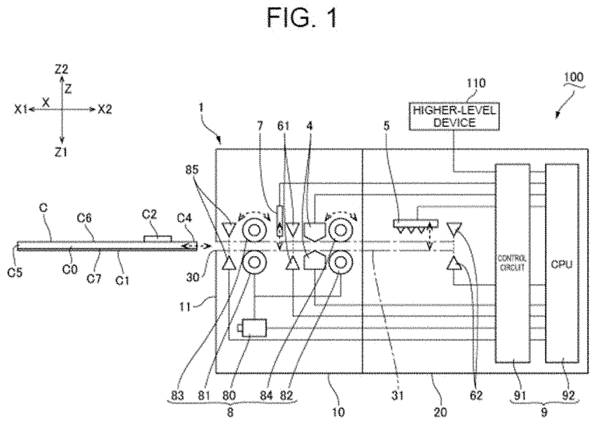

FIG. 1 is an explanatory diagram illustrating a schematic configuration or the like of a card reader 1 to which at least an embodiment of the present invention has been applied. The card reader 1 illustrated in FIG. 1 performs at least one of reading of magnetic data recorded in the card C and recording of magnetic data to the card C in a transaction apparatus 100 such as a parking lot payment machine or a drive-through ATM. In such a card reader 1, the card C is inserted from the front side X1, and then the card C is pulled out to the front side X1. The card reader 1 is controlled by a higher-level device 110 provided in the transaction apparatus 100.

A base material C0 of the card C is, for example, a thin rectangular card made of vinyl chloride having a thickness of about 0.7 to 0.8 mm, and a magnetic stripe C1 in which magnetic data is recorded is formed on a lower surface C7 of the card C. An IC chip C2 is fixed to an upper surface C6 of the card C. In other words, the card C in this embodiment is a contact IC card with a magnetic stripe. The card C may be a contactless IC card with a magnetic stripe. In addition, the base material C0 of the card C may be a polyethylene terephthalate (PET) card having a thickness of approximately 0.18 mm to 0.36 mm, or a paper card or the like having a predetermined thickness.

The card reader 1 has a front cover 10 in which an insertion slot 30 into which the card C is inserted is provided on a front wall 11, and a frame 20 coupled to the rear side of the front cover 10. In the interior of the front cover 10 and the frame 20, a conveyance path 31 extending from the insertion slot 30 to the rear side X2 is provided, and the card C moves along the conveyance path 31. On the upstream side of the conveyance path 31, at the rear side X2 from the insertion slot 30, a front sensor 61 is provided to detect the presence or absence of the card C, and on the downstream end of the conveyance path 31, a rear sensor 62 is provided to detect the presence or absence of the card C. The front sensor 61 and rear sensor 62 are optical sensors such as photocouplers.

In the conveyance path 31, at the rear side X2 of the front sensor 61, a magnetic head 4 which reads and records magnetic data with the magnetic stripe C1 of the card C during conveyance of the card C inserted from the insertion slot 30. In addition, in the conveyance path 31, at the rear side X2 of the magnetic head 4 and at the front side X1 of the rear sensor 62, an IC contact point 5 which performs at least one of reading and recording of information with the IC chip C2 of the card C is provided. The IC contact point 5 is electrically connected to the terminal of the IC chip C2 by moving in the up-down direction.

The card reader 1 is provided with a controller 9 equipped with a control circuit 91 and a CPU 92, and the higher-level device 110 of the transaction apparatus 100 controls the card reader 1 via the controller 9. In addition, the detection results of the front sensor 61 and the rear sensor 62 are input to the controller 9 via a signal line. Moreover, the magnetic head 4 and the control circuit 91 are electrically connected by the signal line, and the IC contact point 5 and the control circuit 91 are electrically connected by the signal line.

The card reader 1 is provided with a shutter member 7 between the insertion slot 30 and the front sensor 61, and the shutter member 7 opens and closes the conveyance path 31 on the basis of a signal or the like output from the controller 9 via the signal line. Although the figures are omitted, in this embodiment, the shutter member 7 is configured as a spring-loaded extraction prevention lever, and the extraction prevention lever engages with the card C to prevent extraction of the card C, and opens and closes the conveyance path 31 by driving by a solenoid. In this embodiment, the front sensor 61 detects the displacement of the extraction prevention lever when the card C contacts the extraction prevention lever, thereby detecting the presence or absence of the card C on the upstream side of the conveyance path 31.

The card reader 1 of this embodiment is provided with a conveyance mechanism 8 that conveys the card C inserted from the insertion slot 30 along the conveyance path 31, and an entry sensor 85 that detects the insertion of the card C into the insertion slot 30. The entry sensor 85 is disposed at the front side X1 of the conveyance mechanism 8.

The conveyance mechanism 8 includes a motor 80 that operates on the basis of a signal output from the controller 9 via the signal line, drive rollers 81 and 82 to which the rotational output of the motor 80 is transmitted, and support rollers 83 and 84 that face the drive rollers 81 and 82 via the conveyance path 31. The support rollers 83 and 84 support the card C from the side opposite to the drive rollers 81 and 82. The drive rollers 81 and 82 drive the card C from the lower side Z1, and the support rollers 83 and 84 support the card C from the upper side Z2. The conveyance mechanism 8 has a gear transmission mechanism to be described below, and the rotational output of the motor 80 is transmitted to the drive rollers 81 and 82 via the gear transmission mechanism.

The drive roller 81 and the support roller 83 are disposed between the entry sensor 85 and the magnetic head 4 in the front-rear direction X. More specifically, the drive roller 81 and the support roller 83 are disposed between the entry sensor 85 and the shutter member 7 in the front-rear direction X. The drive roller 82 and the support roller 84 are disposed between the magnetic head 4 and the IC contact point 5 in the front-rear direction X.

In the card reader 1 having such a configuration, the card C inserted from the insertion slot 30 is conveyed along the conveyance path 31 by the conveyance mechanism 8, and thus the card C can be conveyed at a certain speed, or the like, and the card C can be properly inserted and carried out. Accordingly, even when the operation is performed in a car or the like because the card reader is used in a parking lot payment machine or a drive-through type transaction apparatus, communication between the card C and the magnetic head 4 can be ensured.

### Configuration of Front Cover 12, etc.

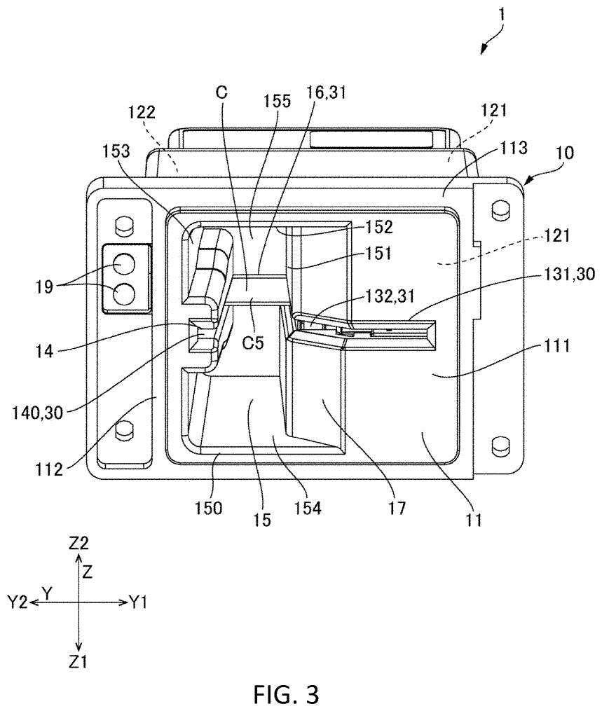

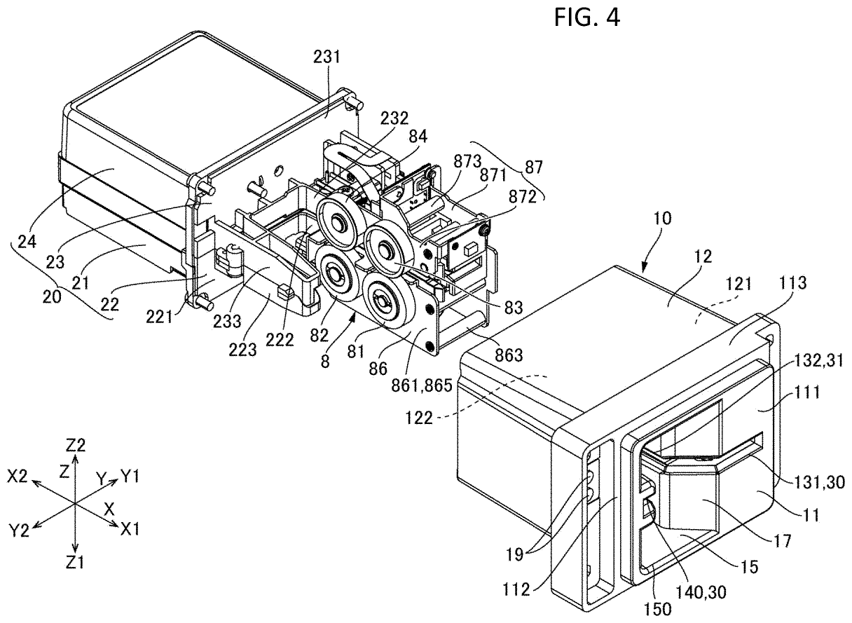

FIG. 2 is a perspective view of the card reader 1 to which at least an embodiment of the present invention has been applied. FIG. 3 is an explanatory of the front of the card reader 1 illustrated in FIG. 1, viewed from diagonally above. FIG. 4 is an exploded perspective view of the card reader 1 illustrated in FIG. 1 with the front cover 10 removed. FIG. 2 illustrates an attempt to insert the card C. FIG. 3 illustrates the card C being conveyed along the conveyance path 31 to the backmost side.

As illustrated in FIG. 2, FIG. 3, and FIG. 4, in the card reader 1, the front cover 10 includes a front wall 11 and a cylindrical body section 12 extending from the front wall 11 to the rear side. The front wall 11 has an external shape of an approximate quadrangle when viewed from the front side X1, and the outer periphery is a flange section 113 for fixing the card reader 1 to the transaction apparatus 100.

The front cover 10 has a recess 15 recessed from the front wall 11 toward the rear side X2 (back side), and the recess 15 is shaped to be hollowed out except for the portion where both ends of the card C pass through. The recess 15 forms a vertically long quadrangular opening 150 when viewed from the front, and the recess 15 is surrounded by four side walls 151, 152, 153, and 154. Among the four side walls 151, 152, 153, and 154, at the side wall 153 on the left side Y2, a groove 14 constituting the conveyance path 31 extends in the front-rear direction X. A portion 140 of the groove 14 opening at the front wall 11 constitutes a part of the insertion slot 30. A slit 13 is continuously formed in the side wall 151 on the right side Y1 and the front wall 11, and a portion of the slit 13 formed in the front wall 11 constitutes a portion of the insertion slot 30, and a portion of the slit 13 formed in the side wall 151 constitutes a portion of the conveyance path 31.

A rear wall 155 is provided at the back of the recess 15, and a slit 16, which constitutes a part of the conveyance path 31, is formed in the rear wall 155 so as to extend in the right-left direction Y. Accordingly, the card C can be conveyed in such a manner that the front end C4 of the card C passes through the slit 16 and reaches the inside of the frame 20.

In this embodiment, as illustrated in FIG. 3, even when the card C is conveyed to the most rear side X2 (back side) along the conveyance path, the rear end C5 of the card C protrudes from the rear wall 155 to the front side X1. Accordingly, both sides of the rear end C5 of the card C are exposed inside the recess 15, and there is space on both sides of the rear end C5 of the card C in the up-down direction Z to insert a fingertip and pick the rear end C5 of the card C. Hence, even if, after inserting the card C, a power failure or a malfunction occurs in the card reader 1 and the card C cannot be conveyed, a user can manually pull out the card C.

Here, in the cylindrical body section 12 of the front cover 10, the rear side X2 of a first front wall portion 111 and the rear side X2 of a second front wall portion 112 are each a first space 121 and a second space 122 that are adjacent via the side wall 151 of the recess 15. In this embodiment, the first front wall portion 111 has a larger width dimension, which is a dimension in the right-left direction, than the width dimension of the second front wall portion 112. Accordingly, the first space 121 is larger in width dimension than the second space 122, and the entry sensor 85, conveyance mechanism 8, shutter member 7, front sensor 61, and magnetic head 4 that has been described with reference to FIG. 1 are disposed in the first space 121. In this embodiment, in disposing the entry sensor 85, conveyance mechanism 8, shutter member 7, front sensor 61, and magnetic head 4 in the first space 121, these members are disposed on the rear side X2, and no member is disposed near the intersection of the side wall 151 and the first front wall portion 111. Accordingly, between the side wall 151 and the first front wall portion 111, an inclined wall 17 is provided being inclined with respect to the side wall 151 and the front wall 11 so as to widen the frontage of the recess 15. Therefore, when manually pulling out the card C, it is easy to insert a fingertip deep into the recess 15.

The second front wall portion 112 is provided with an infrared sensor 19 that detects a human movement. When the infrared sensor 19 is in standby mode, in which no human movement is detected, the shutter member 7 closes the conveyance path 31, and the card C cannot be inserted into the card reader 1. In this state, when the infrared sensor 19 detects a human movement, the shutter member 7 opens the conveyance path 31 to allow insertion of the card C.

### Configuration of Conveyance Mechanism 8, etc.

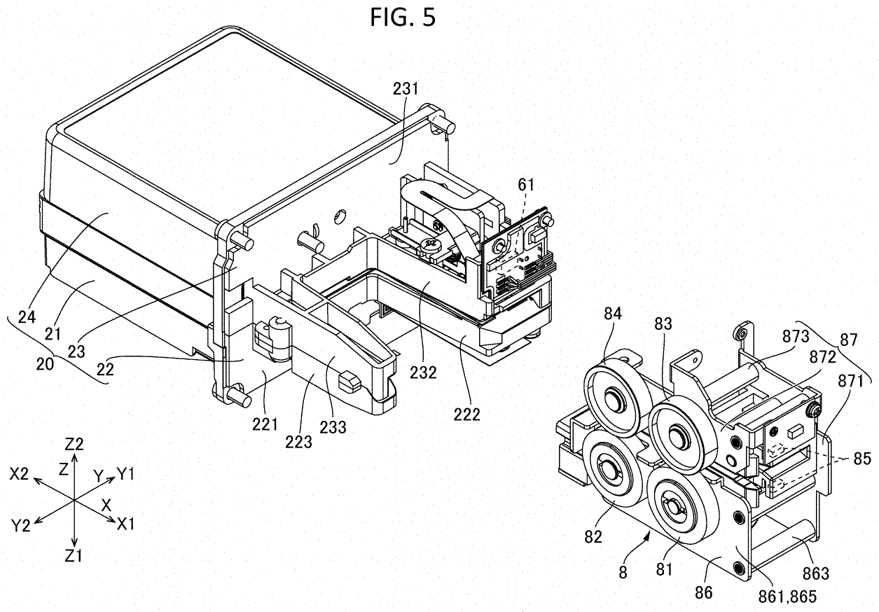

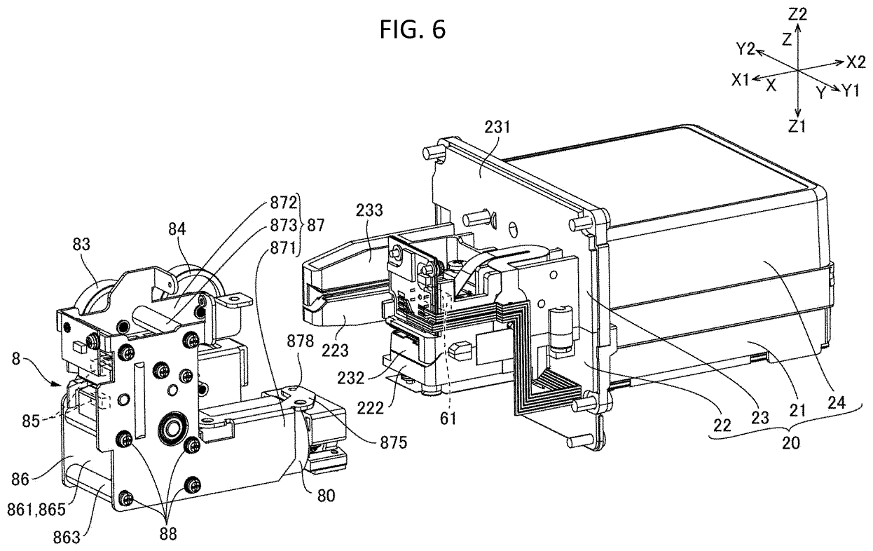

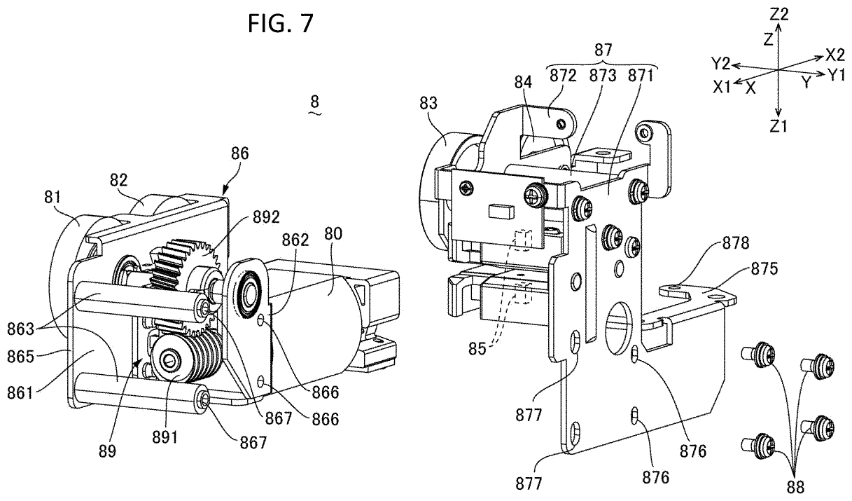

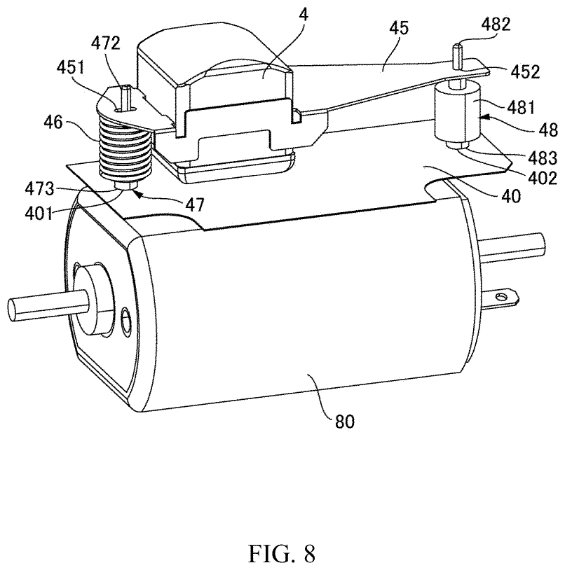

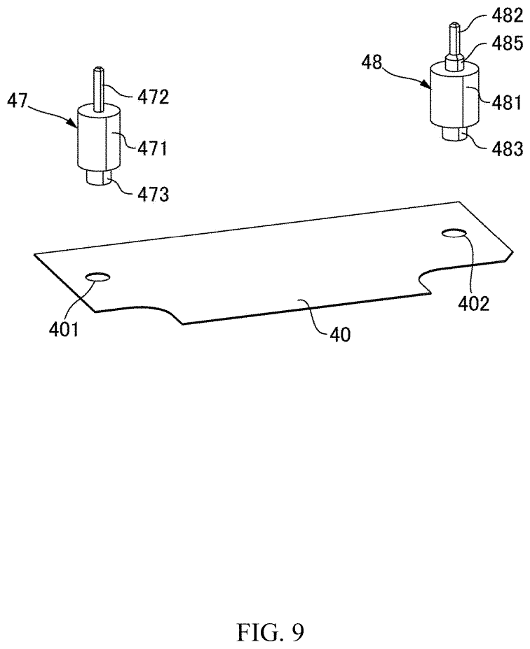

FIG. 5 is an exploded perspective view of the card reader 1 illustrated in FIG. 2 with the conveyance mechanism 8 removed, viewed from the diagonally left side. FIG. 6 is an exploded perspective view of the card reader 1 illustrated in FIG. 1 with the conveyance mechanism 8 removed, viewed from the diagonally right side. FIG. 7 is an exploded perspective view of the conveyance mechanism 8 illustrated in FIG. 6. FIG. 8 is an explanatory diagram of a shield plate 40 provided in the card reader 1 illustrated in FIG. 2. FIG. 9 is an explanatory diagram of coupling members 47 and 48 for fixing the shield plate 40 illustrated in FIG. 8.

As illustrated in FIGS. 4, 5, and 6, the frame 20 includes a plurality of frame members 21, 22, 23, and 24 overlapping one another in the up-down direction. The frame member 22 includes a first end plate section 221 overlapping the front cover 10 from the rear side X2, a first protruding section 222 protruding from the first end plate section 221 toward the interior of the first space 121 of the front cover 10, and a second protruding section 223 protruding from the first end plate section 221 toward the interior of the second space 122 of the front cover 10. In addition, the frame member 23 overlapping the frame member 22 from the upper side Z2 includes a second end plate section 231 overlapping the front cover 10 from the rear side X2, a third protruding section 232 protruding from the second end plate section 231 toward the interior of the first space 121 of the front cover 10, and a fourth protruding section 233 protruding from the second end plate section 231 toward the interior of the second space 122 of the front cover 10.

Here, in a state where the frame members 22 and 23 coupled to the front cover 10, a gap that serves as the conveyance path 31 is secured between the frame members 22 and 23, and a space is secured in which the IC contact point 5 can move in the up-down direction Z. In addition, in a state where the frame members 22 and 23 coupled to the front cover 10, the first end plate section 221 of the frame member 22 is located at Z1 below the slit 16 formed in the rear wall 155 of the recess 15 illustrated in FIG. 3, and the second end plate section 231 of the frame member 23 is located at Z2 above the slit 16. Accordingly, the conveyance path 31 extends from the slit 16 through the first end plate section 221 and the second end plate section 231 toward the rear side X2.

In this embodiment, the entry sensor 85, conveyance mechanism 8, shutter member 7, front sensor 61, and magnetic head 4 illustrated in FIG. 1 are disposed inside the first space 121 in the state of being supported by the first protruding section 222 and the third protruding section 232. Accordingly, even when the conveyance mechanism 8 is provided, it is possible to avoid increasing the size of the card reader 1.

Here, the shutter member 7, front sensor 61, and magnetic head 4 are directly supported by the first protruding section 222 and the third protruding section 232. In contrast, the entry sensor 85 and the conveyance mechanism 8 are supported by the first protruding section 222 and the third protruding section 232 via a first support member 86 and a second support member 87.

More specifically, the first support member 86 supports the motor 80 and movable members such as the drive rollers 81 and 82, and the second support member 87 is supported by the first protruding section 222 and the third protruding section 232 in the state of supporting the support rollers 83 and 84 and the entry sensor 85. In this embodiment, the conveyance mechanism 8 is provided with a gear transmission mechanism 89 that transmits the rotation of the motor 80 to the drive rollers 81 and 82, and gears such as a worm gear 891 and a worm wheel 892 that constitute the gear transmission mechanism 89 are supported by the first support member 86 together with the motor 80 and the drive rollers 81 and 82.

As illustrated in FIG. 7, the first support member 86 and the second support member 87 are coupled by a fastening member 88, such as a screw, which passes through a hole formed in one of the first support member 86 and the second support member 87 and an elongate hole formed in the other of the first support member 86 and the second support member 87.

In this embodiment, the first support member 86 includes a plate 865 provided with a drive roller support section 861 and a motor support section 862, two coupling pipes 863 fixed to the drive roller support section 861, and a total of four perfectly circular holes 866 and 867 are provided in the motor support section 862 and the coupling pipes 863. The gear transmission mechanism 89 is supported between the drive roller support section 861 and the motor support section 862.

The second support member 87 includes a first plate 871, a second plate 872 supporting the support rollers 83 and 84, and a coupling pipe 873 coupling the first plate 871 and the second plate 872. The entry sensor 85 is supported between the first plate 871 and the second plate 872. In the first plate 871, elongate hole-shaped holes 876 and 877 having a long axis oriented in the up-down direction Z are formed at the portions where the four holes 866 and 867 of the first support member 86 overlap. Accordingly, after attaching the magnetic head 4 or the like to the first protruding section 222 and the third protruding section 232, the second support member 87 to which the support rollers 83 and 84, or the like have been attached is fixed to the first protruding section 222 and the third protruding section 232. After that, the first support member 86 supporting the motor 80 or the like is positioned with respect to the second support member 87 in the up-down direction Z in which the long axis of the holes 876 and 877 is oriented, and then the first support member 86 and the second support member 87 can be coupled by the fastening member 88.

In this assembled state, the motor 80 and the magnetic head 4 are disposed so as to overlap, as illustrated in FIG. 8. In this embodiment, the motor 80 overlaps the magnetic head 4 in close proximity to the position directly below the magnetic head 4. That is, since the position directly below the magnetic head 4 is a dead space in conventional card readers, the size of the front cover 10 in the up-down direction can be reduced by placing the motor 80 directly below the magnetic head 4.

In this embodiment, the magnetic head 4 and the motor 80 are disposed so as to be overlapped with each other via the shield plate 40 made of a high magnetic permeability material such as permalloy. Accordingly, magnetic interference from the motor 80 to the magnetic head 4 can be avoided. Here, since the magnetic head 4 needs to be swingable by the swing member 45, the shield plate 40 and the swing member 45 are supported by the plate section 875 extending toward the side of the motor 80 in the first plate 871 of the second support member 87 illustrated in FIG. 6 and FIG. 7.

In this embodiment, the shield plate 40 and the swing member 45 are connected via two coupling members 47 and 48 which are coupled to the plate section 875 of the first plate 871 by swaging via the shield plate 40. As illustrated in FIG. 8 and FIG. 9, the coupling member 47 includes a cylindrical body section 471, a first shaft section 472 protruding from the body section 471 to the upper side Z2, and a second shaft section 473 protruding from the body section 471 to the lower side Z1. The coupling member 48 includes a cylindrical body section 481, a small diameter section 485 protruding from the body section 481 to the upper side Z2, a third shaft section 482 protruding from the small diameter section 485 to the upper side Z2, and a fourth shaft section 483 protruding from the body section 481 to the lower side Z1. Two holes 878 are formed in the plate section 875 of the first plate 871. Two holes 401 and 402 are formed in the shield plate 40. Accordingly, after passing the second shaft second shaft section 473 of the coupling member 47 and the fourth shaft section 483 of the coupling member 48 through the two holes 878 of the plate section 875 and the two holes 401 and 402 of the shield plate 40, respectively, the second shaft section 473 and the fourth shaft section 483 are swaged, and the coupling members 47 and 48 are respectively coupled to the plate section 875 and the shield plate 40. In addition, the first shaft section 472 of the coupling member 47 and the third shaft section 482 of the coupling member 48 are passed through an elongate hole-shaped hole 451 and a perfectly circular hole 452 of the swing member 45, respectively. In doing so, in the coupling member 47, a compression coil spring 46 is disposed between the body section 471 and the swing member 45, and in the coupling member 48, the swing member 45 is received by the small diameter section 485. Accordingly, when contacting the card C, the magnetic head 4 will contact the card C with elasticity. In addition, since the shield plate 40 is connected to the swing member 45 via the axial coupling members 47 and 48 coupled to the shield plate 40 by swaging, even in a case where the shield plate 40 coupled to the swing member 45 is disposed between the magnetic head 4 and the motor 80, the distance between the magnetic head 4 and the motor 80 is narrow, which is preferable.

### Schematic Operation of Card Reader 1 and Transaction Apparatus 100

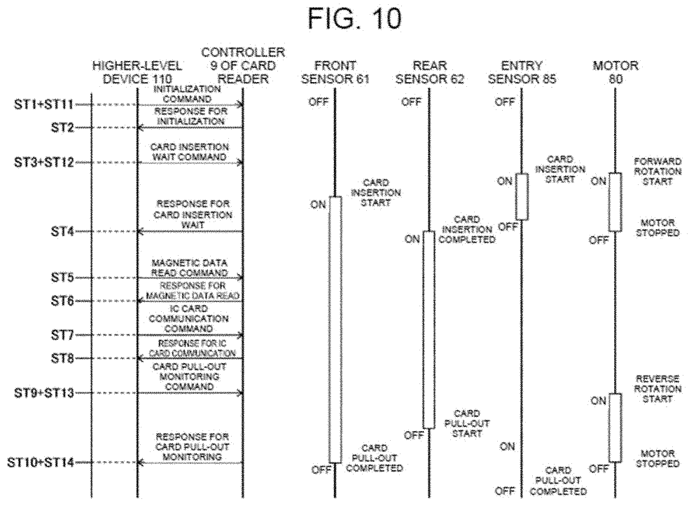

FIG. 10 is an explanatory diagram illustrating a schematic operation of the card reader 1 and the transaction apparatus 100, to which at least an embodiment of the present invention has been applied. In a manual card reader without the conveyance mechanism 8, steps ST1 to ST10 illustrated in FIG. 10 are executed. In the motor conveyance type card reader 1 of this embodiment, the controller 9 executes the steps ST1 to ST10 illustrated in FIG. 10, and at the same time uses, the commands that have been transmitted from the higher-level device 110 in the manual card reader, such as the initialization command and the card pull-out monitoring command, as they are to convey the card C by the conveyance mechanism 8. Accordingly, even when the motor conveyance type card reader 1 of this embodiment is mounted in place of a manual card reader without the conveyance mechanism 8, no change is required for the higher-level device 110 provided in the transaction apparatus 100. Therefore, it is easy to switch from a card reader without the conveyance mechanism 8 to the card reader 1 with the conveyance mechanism 8.

More specifically, as illustrated in FIG. 10, first, in step ST1, the higher-level device 110 outputs an initialization command to the controller 9 of the card reader 1 to initialize the card reader 1. At this timing, upon receipt of the initialization command, the controller 9 of the card reader 1 performs an insertion monitoring start instruction step ST11 to start monitoring the insertion of the card C by the entry sensor 85.

Next, in step ST2, the controller 9 of the card reader 1 responds to the higher-level device 110 that the initialization has been completed.

Next, in step ST3, the higher-level device 110 outputs a card insertion wait command to the controller 9 of the card reader 1. After that, when the entry sensor 85 is turned on and the insertion of a card C is detected in the card reader 1, the controller 9 causes the motor 80 to start forward rotation and performs a carry-in start instruction step ST12 to start taking in the card C.

Next, in step ST4, when the front sensor 61 and the rear sensor 62 are turned on and the insertion of the card C is completed, the controller 9 of the card reader 1 stops the motor 80 and responds to the higher-level device 110 that the insertion of the card C is completed. Next, in steps ST5 to ST8, the higher-level device 110 outputs a magnetic data read command and a communication command with the IC chip C2 to the controller 9 of the card reader 1 in accordance the content of the transaction, and the controller 9 of the card reader 1 performs processing corresponding to those commands and then responds accordingly.

Next, in step ST9, the higher-level device 110 outputs a card pull-out monitoring command to the controller 9 of the card reader 1, and the controller 9 starts monitoring the pull-out of the card C. At this timing, upon receipt of the card pull-out monitoring command, the controller 9 of the card reader 1 starts reversing the motor 80 and performs a carry-out start instruction step ST13 to start carry-out of the card C by the conveyance mechanism 8.

Next, in step ST10, the controller 9 of the card reader 1 stops the motor 80 when the front sensor 61 and the rear sensor 62 are turned off and the carry-out of the card C is completed, and also responds to the higher-level device 110 that the carry-out of the card C is completed. In addition, when the entry sensor 85 is turned off and the card C is detected to be carried out, the controller 9 performs an insertion monitoring resumption instruction step ST14 to resume monitoring the insertion of the card C by the entry sensor 85, and returns to the step ST3.

In a case where the shutter member 7 is closed during the period when reading of information from the card C, or the like is performed, the card C may be carried out by the conveyance mechanism 8 at the timing when the reading of information from the card C, or the like is completed and the shutter member 7 is opened.

### Other Embodiment

In the above embodiment, the card reader 1 includes the magnetic head 4 and the IC contact point 5, but at least an embodiment of the present invention may be applied when the card reader 1 includes only the magnetic head 4.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

What is claimed is:

1. A card reader for use with a card comprising:
a front wall where an insertion slot opens;
a conveyance path extending from the insertion slot toward a back side;
a magnetic head reading information from the card conveyed along the conveyance path;
a conveyance mechanism conveying the card inserted into the insertion slot along the conveyance path;
an entry sensor detecting that the card has been inserted into the insertion slot; and
a controller,
wherein the controller performs an insertion monitoring start instruction step to start monitoring insertion of the card by the entry sensor upon receipt of an initialization command transmitted from a higher-level device and a carry-in start instruction step to start carry-in of the card by the conveyance mechanism when the entry sensor detects the insertion of the card.

2. The card reader according to claim 1, wherein the controller performs a carry-out start instruction step to start carry-out of the card by the conveyance mechanism upon receipt of a card pull-out monitoring command transmitted from the higher-level device and an insertion monitoring resumption instruction step to resume monitoring the insertion of the card by the entry sensor when the entry sensor detects the carry-out of the card.

3. The card reader according to claim 2, comprising:
a front sensor detecting presence or absence of the card on an upstream side of the conveyance path; and
a rear sensor detecting presence or absence of the card on a downstream side of the conveyance path,
wherein after the carry-in start instruction step, the controller stops the carry-in of the card by the conveyance mechanism based on a detection result by the front sensor that the card is present and a detection result by the rear sensor that the card is present, and after the carry-out start instruction step, the controller stops the carry-out of the card by the conveyance mechanism based on a detection result by the front sensor that the card is absent and a detection result by the rear sensor that the card is absent.

4. A transaction apparatus comprising a card reader for use with a card and a higher-level device to control the card reader, the card reader comprising:
a front wall where an insertion slot opens;
a conveyance path extending from the insertion slot toward a back side;
a magnetic head reading information from the card conveyed along the conveyance path;
a conveyance mechanism conveying the card inserted into the insertion slot along the conveyance path;
an entry sensor detecting that the card has been inserted into the insertion slot; and
a controller,
wherein the controller performs an insertion monitoring start instruction step to start monitoring insertion of the card by the entry sensor upon receipt of an initialization command transmitted from the higher-level device and a carry-in start instruction step to start carry-in of the card by the conveyance mechanism when the entry sensor detects the insertion of the card.

5. The transaction apparatus according to claim 4, wherein the controller performs a carry-out start instruction step to start carry-out of the card by the conveyance mechanism upon receipt of a card pull-out monitoring command transmitted from the higher-level device and an insertion monitoring resumption instruction step to resume monitoring the insertion of the card by the entry sensor when the entry sensor detects the carry-out of the card.

6. The transaction apparatus according to claim 5, the card reader comprising:
a front sensor detecting presence or absence of the card on an upstream side of the conveyance path; and
a rear sensor detecting presence or absence of the card on a downstream side of the conveyance path,
wherein after the carry-in start instruction step, the controller stops the carry-in of the card by the conveyance mechanism based on a detection result by the front sensor that the card is present and a detection result by the rear sensor that the card is present, and after the carry-out start instruction step, the controller stops the carry-out of the card by the conveyance mechanism on a basis of a detection result by the front sensor that the card is absent and a detection result by the rear sensor that the card is absent.
